(19) United States
(12) Patent Application Publication
(10) Pub. No.: US 2016/0300419 A1
(43) Pub. Date: Oct. 13, 2016

(54) MONITORING ACTIONS TO CONDUCT AN ACTIVITY BETWEEN MULTIPLE PARTICIPANTS

(71) Applicant: International Business Machines Corporation, Armonk, NY (US)

(72) Inventors: Ilse M. Breedvelt-Schouten, Ontario (CA); Jana H. Jenkins, Raleigh, NC (US); Jeffrey A. Kusnitz, Campbell, CA (US); James L. Lentz, Austin, TX (US)

(21) Appl. No.: 14/970,975

(22) Filed: Dec. 16, 2015

Related U.S. Application Data
(63) Continuation of application No. 14/683,294, filed on Apr. 10, 2015.

(51) Int. Cl. G07C 13/00; H04L 12/58; H04L 29/06; G06Q 50/00; G06F 17/30

(52) U.S. Cl. CPC G07C 13/00; G06Q 50/01; G06F 17/30991; H04L 65/403; H04L 51/32

(57) ABSTRACT

According to one embodiment of the present invention, a system determines the best option for accomplishing or performing an activity between multiple participants and may send a notification to the multiple participants of the determined best option. The system analyzes the preferences, limitations, behaviors, and capabilities of each of the participants and displays an aggregate of these traits from each of participants. The system then applies a set of rules and guidelines for determining which option is best suited for performing the activity with all of the participants. The system comprises a computer system including at least one processor. Embodiments of the present invention further include a method and computer program product for determining the best option for accomplishing or performing an activity between multiple participants in substantially the same manner described above.

### CROSS-REFERENCE TO RELATED APPLICATIONS

This application is a continuation of U.S. patent application Ser. No. 14/683,294, entitled “MONITORING ACTIONS TO CONDUCT AN ACTIVITY BETWEEN MULTIPLE PARTICIPANTS” and filed Apr. 10, 2015, the disclosure of which is incorporated herein by reference in its entirety.

### BACKGROUND

Present invention embodiments relate to a system and method for monitoring actions and determining the best option for performing an activity with the multiple participants.

The world is becoming more connected and interactive with one another. Often, people perform activities with other participants, such as family members, friends, coworkers, etc. Performing an activity may encompass things such as performing an action, attending an event, partaking in a hobby, etc. However, when multiple participants perform or complete any activity, each participant has their own preference for how the activity should be accomplished. Furthermore, each participant may only have the capabilities for performing an activity in a certain manner, while not being able to perform the activity in the manner other participants are capable of. Furthermore, a participant is often more familiar with one option for accomplishing an activity vs. another. Thus, choosing the option or manner in which to accomplish the activity may require a negotiation between the multiple participants.

For example, when the activity to be performed, is attending an event, such as going to the movies, each participant that will be attending the movie together may have different preferences about which movie to attend because multiple movies are available for the same date. Thus, the participants must negotiate with each other to determine which movie is best suited for the majority of the participants to attend. In another example, when the activity to be performed is conducting a teleconference, each participant in the teleconference may have a different preference about which platform to use for the teleconference. For example, one participant may prefer conducting the teleconference via Skype, while another participant may prefer conducting the teleconference via Facebook, and a third participant may prefer conducting the teleconference via Sametime.

### SUMMARY

According to one embodiment of the present invention, a system for conducting an activity among a plurality of participants includes a computer system containing at least on processor. The at least one processor may be configured to generate a graphical display of magnitudes of preferences of each participant pertaining to each of a plurality of options for an item required for conducting an activity, combine the magnitudes of the preferences of each participant for each of the options and determine the option for the item to employ for the activity based on the combined magnitudes. The processor may be also configured to then graphically display the determined option for the item to conduct the activity employing the determined option.

According to one embodiment of the present invention, a system determines the best option for accomplishing or performing an activity between multiple participants and may send a notification to the multiple participants of the determined best option. The system analyzes the preferences, limitations, behaviors, and capabilities of each of the participants and displays an aggregate of these traits from each of participants. The system then applies a set of rules and guidelines for determining which option is best suited for performing the activity with all of the participants. The system comprises a computer system including at least one processor. Embodiments of the present invention further include a method and computer program for determining the best option for accomplishing or performing an activity between multiple participants in substantially the same manner described above.

### BRIEF DESCRIPTION OF THE SEVERAL VIEWS OF THE DRAWINGS

Generally, like reference numerals in the various figures are utilized to designate like components.

FIG. 1 is a diagrammatic illustration of an example of a computing environment for use with an embodiment of the present invention.

FIG. 2 is a diagrammatic illustration of a second example of a computing environment for use with an embodiment of the present invention.

FIG. 3A is an example of a graphical user interface that displays the tendencies/behaviors/preferences of the options of an activity of two participants according to an embodiment of the present invention.

FIG. 3B is an interactive feature of the graphical user interface illustrated in FIG. 3A.

FIG. 4A is the graphical user interface of FIG. 3A, where the greatest consensus option of the between the participants is highlighted

FIG. 4B is the graphical user interface of FIG. 3A, where the most preferred option between the participants is highlighted.

FIG. 4C is the graphical user interface of FIG. 3A, where the least disliked option between the participants is highlighted.

FIG. 5A is a second example of a graphical user interface that displays the tendencies/behaviors/preferences of the options of an activity between more than two participants, the values of the first option of each participant are aligned according to an embodiment of the present invention.

FIG. 5B is the graphical user interface of FIG. 5A, where the values of the second option of each participant are aligned.

FIG. 6A is a third example of a graphical user interface that displays the tendencies/behaviors/preferences of the options of an activity between more than two participants, where graphical user interface displays the options in order of most preferred according to a present embodiment of the invention.

FIG. 6B illustrates the steps and methods for interacting with the graphical user interface of FIG. 6A.

FIG. 6C is the graphical user interface of FIG. 6A, where the graphical user interface displays the options in order of least disliked.

FIG. 6D is a second example of the graphical user interface of FIG. 6C, where the graphical user interface displays the options in order of least disliked.

FIG. 6E is the graphical user interface of FIG. 6A, where the graphical user interface displays the options in order of the greatest consensus.

FIG. 6F is the graphical user interface of FIG. 6E, where there is a tie between two options for the greatest consensus of the options.

FIG. 6G is the graphical user interface of FIG. 6E, where there is a tie between two options for the runner up of the greatest consensus of the options.

FIG. 7 is a procedural flow chart illustrating an example of the steps for determining an option from a compiled list of tendencies/behaviors/preferences from each participant for the options of an activity according to an embodiment of the present invention.

FIG. 8 is a procedural flow chart illustrating a second example of the steps for determining an option from a compiled list of tendencies/behaviors/preferences from each participant for the options of an activity according to an embodiment of the present invention.

### DETAILED DESCRIPTION

The present invention embodiments pertain to monitoring the actions, the behavioral tendencies, and the preferences of a plurality of users/participants for an activity, collecting the behavioral tendencies and/or preferences of the plurality of users/participants, and then determining which of the options for completing the activity is best used for the activity based on the compiled behavioral tendencies and/or preferences from the plurality of users/participants.

For example, when a group of participants complete an activity with one another, there may be multiple different options for completing or performing the activity. Each participant will have their own preferences and tendencies for completing or performing the activity, as well as their own limitations and capabilities for completing or performing the activity. One aspect of the embodiment of the present invention may identify the various options that available to each of the participants for performing or completing the activity. The present invention embodiments may then monitor and collect the behavioral tendencies, the preferences, and the capabilities of the multiples participants for each of the options for completing or performing the activity, and may conduct the activity with the best option. The behavioral tendencies/preferences/capabilities may include which options are available to each participant, the frequencies each of these options have been used or chosen by the participants, the preferences of each participant for the options, the order that each participant ranks the options in terms of familiarity, etc.

The present invention embodiments may then present a display of the tendencies/preferences/capabilities of the options to one or all of the participants to illustrate the comparison of the options to each other. The display of the options may be a graphical display that indicates the relative tendency/preference/capability values of each of the options for each of the participants of the activity. The display may also be a control, where interaction with the display may cause a notification be sent to the participants to notify them of the chosen option. In one embodiment of the present invention, the display may be a bar graph, where each of the options for each participant is represented by a bar that is proportional to the relative tendency or preference strength for that option by the respective participant. The display may illustrate the tendency/preference intersections between the multiple participants, which options are currently active and available for each of the participants, and any other properties that are tracked by the present invention. Once the display of the options has been presented, one or all of the users or the system can then determine which of the options is best for performing or completing the activity by all of the participants.

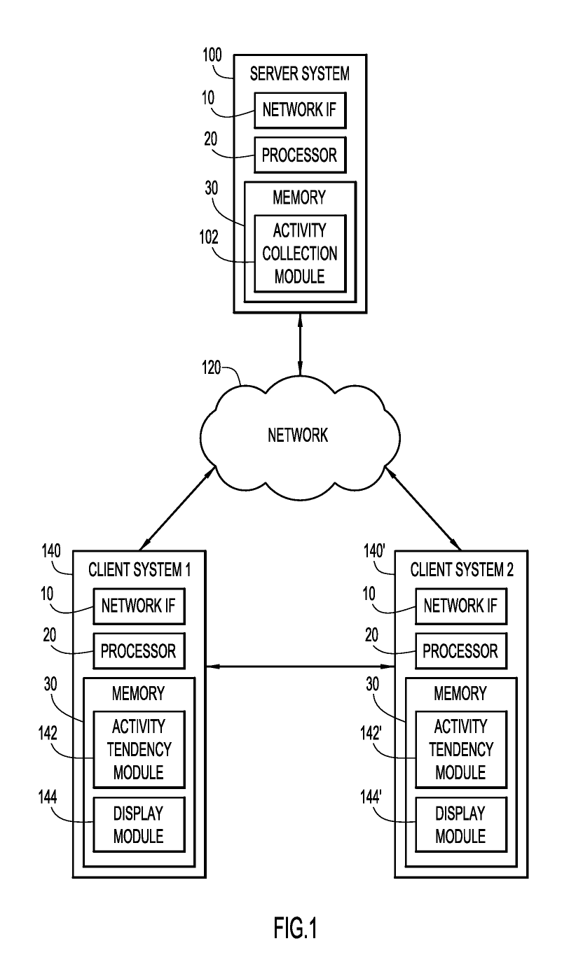

An example environment for use with present invention embodiments is illustrated in FIG. 1. Specifically, the environment includes one or more server systems 100, and one or more client or end-user systems 140, 140′. Server systems 10 and client systems 140, 140′ may be remote from each other and communicate over a network 120. The network 120 may be implemented by any number of any suitable communications media (e.g., wide area network (WAN), local area network (LAN), Internet, Intranet, etc.). Alternatively, server systems 100 and client systems 140, 140′ may be local to each other, and communicate via any appropriate local communication medium (e.g., local area network (LAN), hardwire, wireless link, Intranet, etc.).

Server systems 100 and client systems 140, 140′ may be implemented by any conventional or other computer systems preferably equipped with a display or monitor, a base (e.g., including at least one processor 20, one or more memories 30 and/or internal or external network interfaces or communications devices 10 (e.g., modem, network cards, etc.)), optional input devices (e.g., a keyboard, mouse or other input device), and any commercially available and custom software (e.g., server/communications software, activity collection module, activity tendency module, browser/interface software, etc.).

Client systems 140, 140′ enable users to establish communication links via communication channels (e.g., email, SMS/text messaging, tweeting, instant messaging, audio calls, video chats, etc.) with other client systems 140, 140′ and/or the server system 100. The client systems 140, 140′ may include an activity tendency module 142 that monitors the behavior tendencies/preferences of the client systems 140, 140′ and a display module 144 that forms a display of the behavioral tendencies/preferences of the options of an activity. When the modules 142, 144 are used to monitor and display the behavioral tendencies/strengths of a desired activity between multiple users, the behavioral tendencies/strengths may include which options for performing the desired activity are available to each participant, the frequencies each of these options have been used or are chosen by each participant, the preferences of each participant for each of the options, the order that each participant ranks the options in terms of familiarity, etc. The server system 100 may include an activity collection module 102 to collect the behavioral tendencies from a plurality of client systems 140, 140′.

Alternatively, one or more client systems 140, 140′ may analyze the behavioral tendencies/preferences of a user for other activities such as working on a project, going out to eat, attending a movie/show, or attending a sporting event. The graphical user (e.g., GUI, etc.) or other interface (e.g., command line prompts, menu screens, etc.) solicits information from a corresponding user pertaining to the desired activity, and may provide reports including analysis results.

Modules 102, 142, 142′, 144, 144′ may include one or more modules or units to perform the various functions of present invention embodiments described below. The various modules (e.g., activity tendency module, display module, and activity collection module, etc.) may be implemented by any combination of any quantity of software and/or hardware modules or units, and may reside within memory 30 of the server 100 and/or client systems 140, 140′ for execution by processor 20.

In the environment illustrated in FIG. 1, the activity tendency module 142, 142′ of the client systems 140, 140′ monitors the client system that it is installed on for various behavioral tendencies/preferences related to the options for performing an activity. Once the desire to perform or complete an activity is established, the display module 144, 144′ creates a display of the behavioral tendencies/preferences of the options for that specific client system 140, 140′. Each of the client systems 140, 140′ send to the server system 100 the monitored the behavioral tendencies/preferences, where the activity collection module 102 of the server system 100 compiles all of the behavioral tendencies/preferences from each of the client systems 140, 140′. The server system 100 may then send a display of the behavioral tendencies/preferences back to the first client system 140, or to all of the client systems 140, 140′. The users of the client systems 140, 140′ can analyze the behavioral tendencies/preferences on an interface provided by display modules 144, 144′, and choose the best option for performing the activity.

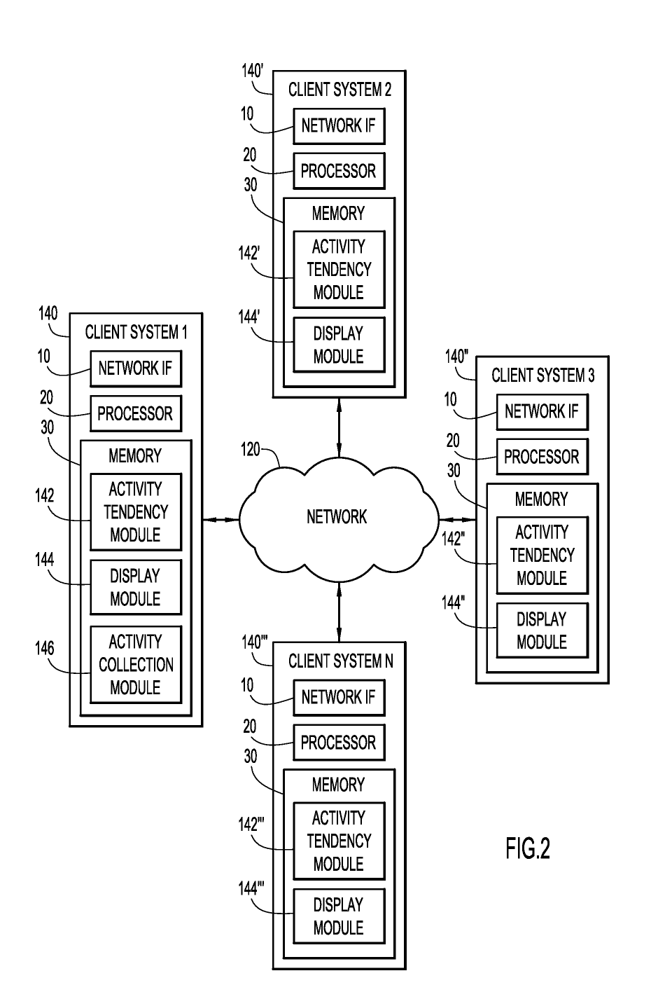

A second example environment for use with present invention embodiments is illustrated in FIG. 2. Similarly to the first example illustrated in FIG. 1, the environment includes two or more client or end-user systems 140, 140′, 140″, 140′″, but does not include the server system 100. Each of the client systems 140, 140′, 140″, 140′″ communicate with one another via a network 120. Each one of the client systems 140, 140′, 140″, 140′″ includes an activity tendency module 142, 142′, 142″, 142′″ and a display module 144, 144′, 144″, 144″. As explained previously, the activity tendency module 142, 142′, 142″, 142′″ of a client system 140, 140′, 140″, 140′″ monitors that respective client system 140, 140′, 140″, 140′″ for various behavioral tendencies/preferences of options for performing an activity, and the display module 144, 144′, 144″, 144′″ creates a display of the behavioral tendencies/preferences for the respective client systems 140, 140′, 140″, 140′″ on which it is installed. The first client system 140, however, also includes an activity collection module 146, which collects all of the displays of the behavioral tendencies/preferences from all of the client systems 140, 140′, 140″, 140′″. The first client system 140 may then display the collected behavioral tendencies/preferences to just the user of the first client system 140, or may send the collected behavioral tendencies/preferences to the various other client systems 140′, 140″, 140′″. In yet another embodiment of the present invention, the other client systems may also contain an activity collection module.

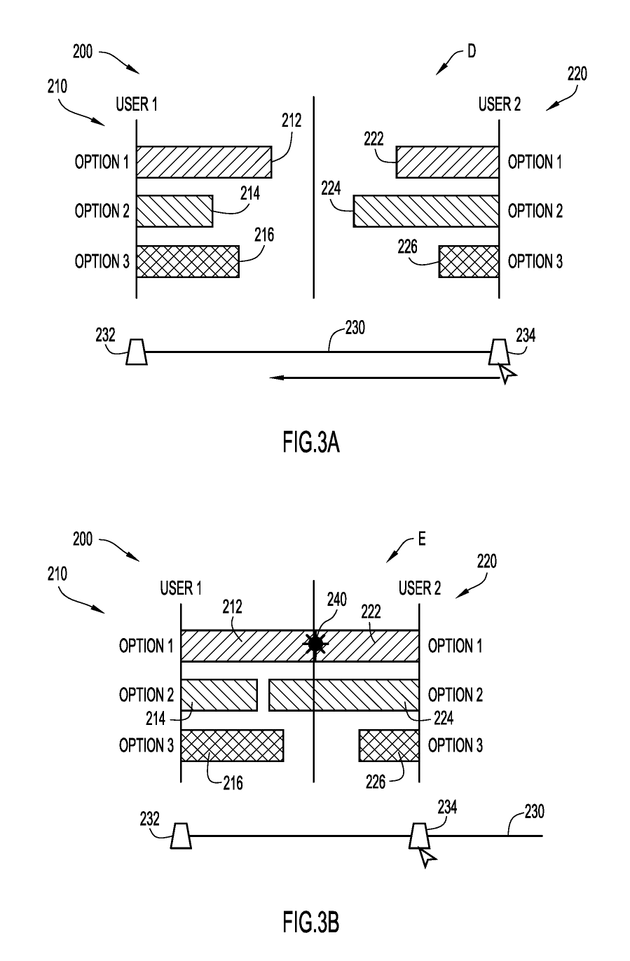

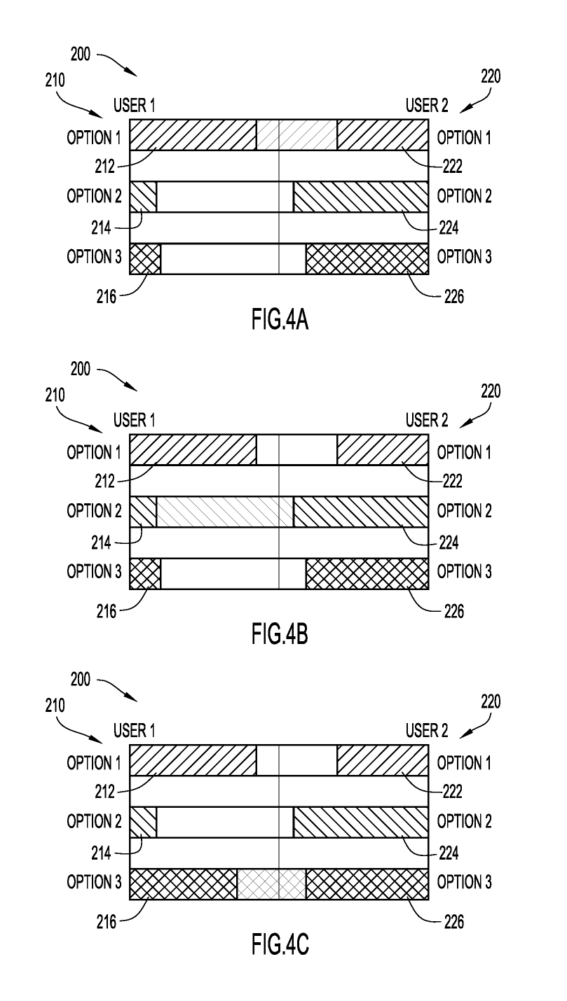

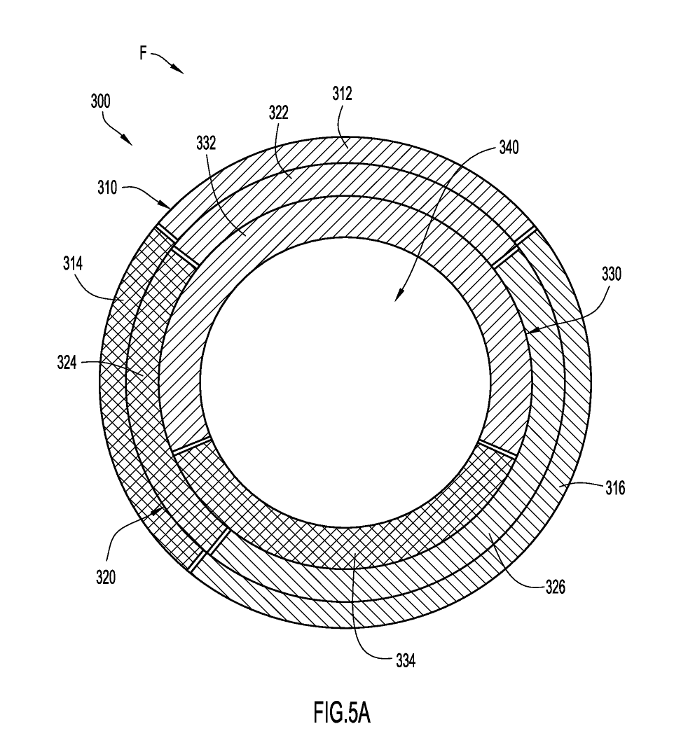

FIGS. 3A, 3B, 4A, 4B, and 4C illustrate an example of a display, or graphical user interface (GUI), of the behavioral tendencies/preferences between two users. As illustrated in FIGS. 3A and 3B, the GUI 200 is a chart containing a set of horizontal bar graphs for a first user 210 and a second user 220, where the bars 212, 214, 216 of the first user 210 extend towards the bars 222, 224, 226 of the second user 220, and vice versa. The GUI 200 displays that each user 210, 220 is capable of performing or completing an activity with one another via three different options. Thus, for the first user 210, the GUI 200 has a bar 212 that represents the first user's behavioral tendencies/preference for Option 1, a bar 214 that represents the first user's behavioral tendencies/preference for Option 2, and a bar 216 that represents the first user's behavioral tendencies/preference for Option 3. Similarly, for the second user 220, the GUI 200 has a bar 222 that represents the second user's behavioral tendencies/preference for Option 1, a bar 224 that represents the second user's behavioral tendencies/preference for Option 2, and a bar 226 that represents the second user's behavioral tendencies/preference for Option 3. The bars 212, 214, 216, 222, 224, 226 are proportional to the relative tendency/preference value for each of the users 210, 220. These tendency/preference values may be determined by an activity collection module based on the numeral weights, scores, etc. that are calculated for criteria related to which options are available to each participant, the frequencies each of these options have been used, the option preference of each participant for the activity, the order that each participant ranks the options in terms of familiarity, etc.

As best illustrated in FIG. 3A, the first user 210 has a stronger tendency/preference towards Option 1, a second strongest tendency/preference towards Option 2, and the least tendency/preference for Option 3. The second user 220 has a stronger tendency/preference towards Option 2, a second strongest tendency/preference towards Option 1, and the least tendency/preference towards Option 3. Thus, the first and second users 210, 220 differ on their tendencies/preferences for how to perform the activity. If one of the users refused to use one of the options, or did not have the necessary capability for implementing a specific option, the GUI 200 may not display a bar for that user for that specific option.

FIGS. 3A and 3B illustrate a slider bar 230 positioned beneath the displayed options of the first user 210 and the displayed options of the second user 220. The slider bar 230 may include a first user button 232 and a second user button 234. As illustrated by the difference between FIGS. 3A and 3B, the slider buttons 232, 234 may be configured to be slid along the slider bar 230. First user slider button 232 controls the positioning of the bars for the options of the first user 210, while second user slider button 234 controls the bars for the positioning of the options of the second user 220. As illustrated in FIG. 3B, the second user slider button 234 has been slid along the slider bar 230 to cause the tendency/preference bars 222, 224, 226 of the second user 220 to move towards the tendency/preference bars 212, 214, 216 of the first user 210. FIG. 3B illustrates that as the second user slider button 234 is slide to the left, the Option 1 tendency/preference bar 212 of the first user 210 contacts the Option 1 tendency/preference bar 222 of the second user 220 before any of the other tendency/preference bars 214, 216 of the first user 210 contact any of the other tendency/preference bars 224, 226 of the second user 220. This contact between the Option 1 bars 212, 222 demonstrates that Option 1 is the option that is best used for performing or completing the activity between these two users 210, 220. Thus, FIG. 3A illustrates a GUI 200 where the tendency/preference values 212, 214, 216 of the first user 210 and the tendency/preference values 222, 224, 226 of the second user 220 are in a separated position D, while FIG. 3B illustrates a GUI 200 where the tendency/preference values 212, 214, 216 of the first user 210 and the tendency/preference values 222, 224, 226 of the second user 220 are in a contacted position E. While FIG. 3B only illustrates the movement of the second user slider button 234, both the first user slider button 232 and the second user slider button 234 may be slid along the slider bar 230.

Once two tendency/preference bars have contacted each other, a connection indicator 240 is formed on the GUI 200. In some embodiments, the connection indicator 240 may be configured to automatically send a notification to the two users 210, 220 once tendency/preference values first come in contact with each other, or initiate the activity. In another embodiment, the connection indicator 240 may be configured to initiate a set of prompts to the users 210, 220 for sending a notification to the two users 210, 220 that one of the options has been chosen.

FIGS. 4A, 4B, and 4C illustrate a similar GUI 200 to that of FIGS. 3A and 3B.

However, the GUI 200 of FIGS. 4A, 4B, and 4C does not include a slider bar 230 with slider buttons 232, 234. Instead, each set of aligned tendency/preference bars (tendency/preference bars 212 and 222 for Option 1, tendency/preference bars 214 and 224 for Option 2, and tendency/preference bars 216 and 226 for Option 3) serve as a push button for selecting that option. In other words, a user 210, 220 may select a set of aligned preference bars for one of the options to notify the other users that an option has been chosen for performing/completing the activity. FIGS. 4A, 4B, and 4C illustrate the application of different rules or guidelines for determining the best choice for the options, and how the application of the rules or guidelines may result in different choices for the best option for performing/completing the activity.

The GUI 200 in FIG. 4A displays that the first user 210 has the strongest tendency/preference towards Option 1, a second strongest tendency/preference towards Option 3, and the least tendency/preference for Option 2. The GUI 200 also displays that the second user 220 has the strongest tendency/preference towards Option 2, a second strongest tendency/preference towards Option 3, and the least tendency/preference towards Option 1. FIG. 4A illustrates the application of the greatest consensus, or largest sum, guidelines to the tendency/preference values for each the options. The greatest consensus guideline sums the tendency/preference values of all of the users 210, 220 for each of the options and highlights the option with the largest combined tendency/preference value. As described above, the tendency/preference values may be determined based on the numeral weights, scores, etc. that are calculated for criteria related to which options are available to each participant, the frequencies each of these options have been used for the activity, the option preferences of each participant for the activity, the order that each participant ranks the options in terms of familiarity, etc. As illustrated in FIG. 4A, Option 1 has the largest combined tendency/preference value when combining tendency/preference bar 212 of the first user 210 and tendency/preference bar 222 of the second user 220, and thus, Option 1 is highlighted. A user 210, 220 may select the highlighted Option 1 set of bars 212, 222 to have a notification sent to the other users 210, 220 of the determined best option for performing/completing the activity.

FIG. 4B illustrates the application of the most preferred guideline to the tendency/preference values for each option. The most preferred guideline highlights the option that contains the largest single user tendency/preference value. As illustrated in FIG. 4B, the GUI 200 displays that the first user 210 has the strongest tendency/preference towards Option 1, a second strongest tendency/preference towards Option 3, and the least tendency/preference for Option 2. The GUI 200 also displays that the second user 220 has the strongest tendency/preference towards Option 2, a second strongest tendency/preference towards Option 3, and the least tendency/preference towards Option 1. As illustrated in FIG. 4B, the tendency/preference value 224 for Option 2 for the second user 220 is larger than the tendency/preference value 212 for Option 1 for the first user 210, indicating that the second user 220 prefers Option 2 more than the first user 210 prefers Option 1. Thus, using the most preferred guideline, the tendency/preference bars 214, 224 for Option 2 are highlighted because the bars 214, 224 contain the single largest tendency/preference value.

FIG. 4C illustrates the application of the least disliked guideline to the tendency/preference values for each of the options. The least disliked guideline highlights the option that does not contain the lowest tendency/preference value from a single user. The least disliked guideline is often used when strong differences between the tendency/preference values of the most preferred options for each user do not exist. As illustrated in FIG. 4C, the GUI 200 displays that the first user 210 has the strongest tendency/preference towards Option 1, a second strongest tendency/preference towards Option 3, and the least tendency/preference for Option 2. The GUI 200 also displays that the second user 220 has the strongest tendency/preference towards Option 2, a second strongest tendency/preference towards Option 3, and the least tendency/preference towards Option 1. Because the tendency/preference bar 214 for Option 2 has the lowest tendency/preference value for the first user 210, and tendency/preference bar 222 for Option 1 has the lowest tendency/preference value for the second user 220, the tendency/preference values 216, 226 for Option 3 are highlighted using the least disliked guidelines. Because Option 3 is not strongly disliked by either the first user 210 or the second user 220, Option 3 is highlighted.

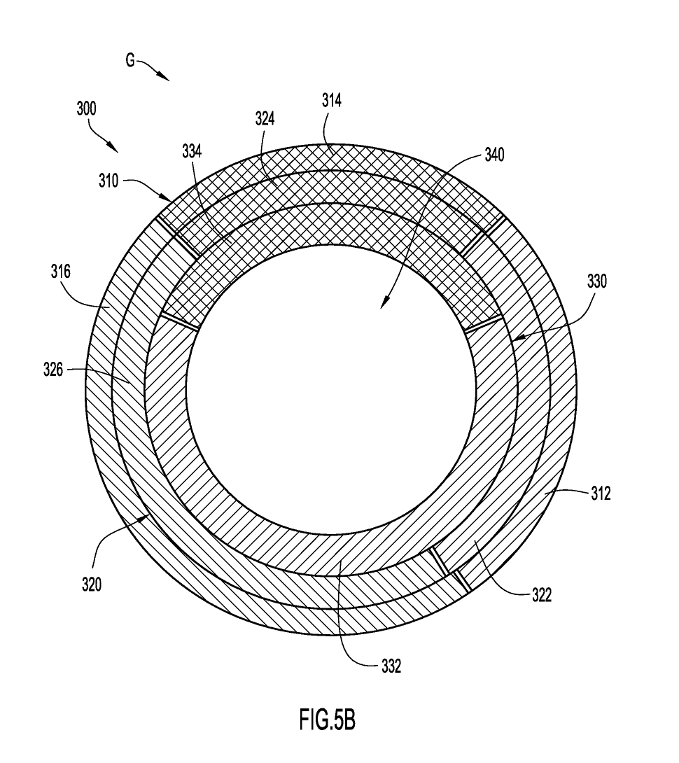

Turning to FIGS. 5A and 5B, illustrated is a second example of a GUI 300, where the GUI 300 combines the tendency/preference values of multiple options for performing/completing an activity for more than two users. As described above, the tendency/preference values may be determined based on the numeral weights, scores, etc. that are calculated for criteria related to which options are available to each participant, the frequencies each of these options have been used for the activity, the option preferences of each participant for the activity, the order that each participant ranks the options in terms of familiarity, etc. While FIGS. 3A, 3B, 4A, 4B, and 4C illustrate GUI's 200 that compare tendency/preference values, the GUI's 200 illustrated in FIGS. 3A, 3B, 4A, 4B, and 4C can only be used for the comparison of two users 210, 220. FIGS. 5A and 5B illustrate a GUI 300 constructed of multiple concentric bands, where each band represents the tendency/preference values of a user. The outer band 310 illustrated in FIGS. 5A and 5B represents a first user, the middle band 320 represents a second user, and the inner band 330 represents a third user. The tendency/preference bands 310, 320, 330 may surround a central area 340. While FIGS. 5A and 5B illustrate only three bands, bands may be added or subtracted to represent adding or subtracting users. For example, if the GUI 300 of FIGS. 5A and 5B were to represent the tendency/preference values of five users, then the GUI 300 would include five concentric bands.

As illustrated in FIGS. 5A and 5B, the first user 310 has tendency/preference values for a first option 312, a second option 314, and a third option 316. The second user 320 has tendency/preference values for the first option 322, the second option 324, and the third option 326. Finally, the third user 330 has tendency/preference values for only the first option 332 and the second option 334. Because the third user 330 may not have the ability or preference to use or perform the third option, the third user 330 does not have a tendency/preference value for the third option.

Because a complete band represents each user 310, 320, 330, the tendency/preference values of the options for each user 310, 320, 330 must add up to the same amount. Thus, each tendency/preference value represents a percentage of a total, and all of the tendency/preference values for each user must equate to 100%. Thus, the GUI 300 example is useful when the tendency/preference values might be based on a percentage. For example, the tendency/preference values may be based on the proportion of time each user chooses each one of the options. As illustrated in FIGS. 5A and 5B, the first user 310 has the largest tendency/preference value for the third option 316, and about equal tendency/preference values for the first option 312 and the second option 314. Similarly, the second user 320 has the largest tendency/preference value for the third option 326, and about equal tendency/preference values for the first option 322 and the second option 324. However, the third user 330 has the largest tendency/preference value for the first option 332, the second largest tendency/preference value for option 334, and does not have a tendency/preference value for the third option.

FIG. 5A illustrates a GUI 300 in a first orientation F, where the tendency/preference values for the first options 312, 322, 332 are aligned with one another for each of the users 310, 320, 330. The GUI 300 illustrated in FIG. 5B is in a second orientation G, where the tendency/preference values for the second options 314, 324, 334 are aligned with one another for each of the users 310, 320, 330. The GUI 300 may be set to guidelines that automatically determine the greatest consensus, which is the first orientation F. Thus, as the GUI is displayed, the bands 310, 320, 330 may be initially rotated to align the option with the option having the greatest consensus of tendency/preference values. However, a user 310, 320, 330 may select one of the misaligned tendency/preference values to align the bands 310, 320, 330 to that specific option. For example, to switch from the first orientation F of the GUI 300 to the second orientation G, a user may select one of the second option tendency/preference values, causing the bands 310, 320, 330 to rotate to align all of the tendency/preference values for the second option, as illustrated in FIG. 5B.

The GUI 300 further includes a central area 340. In some embodiments of the GUI 300, selection of the central area 340 may send a notification to the users 310, 320, 330 that the option that has the aligned tendency/preference values has been chosen or determined as the best option for performing/completing the activity. However, in other embodiments of GUI 300, once the tendency/preference values are aligned for a specific option, selecting one of those aligned tendency/preference values again may send a notification to the users of the selection of one of the options.

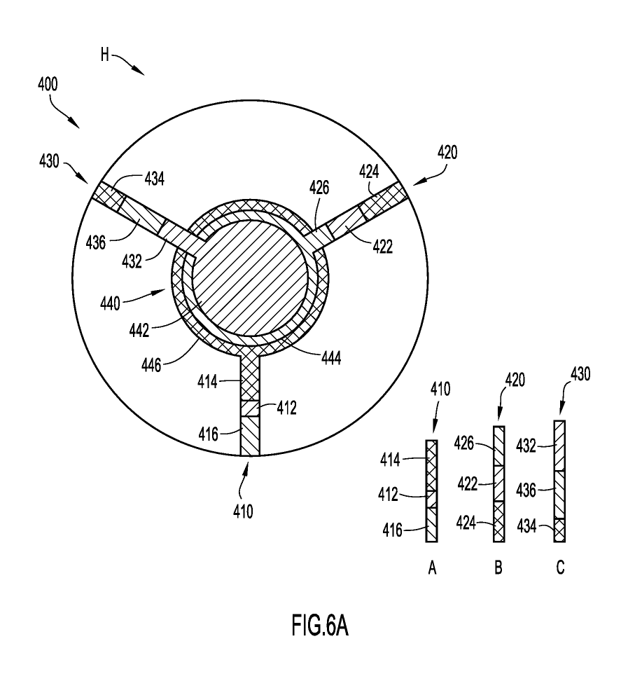

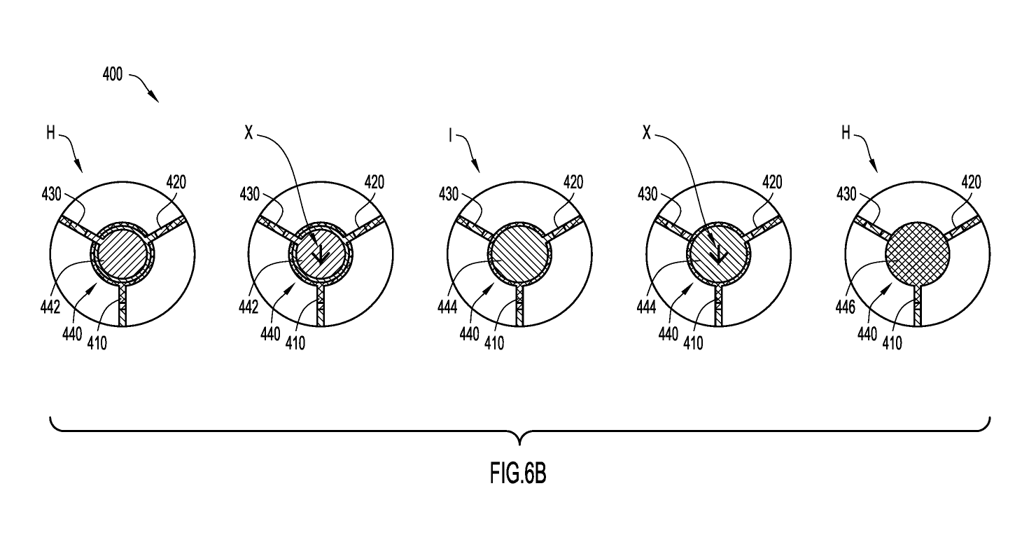

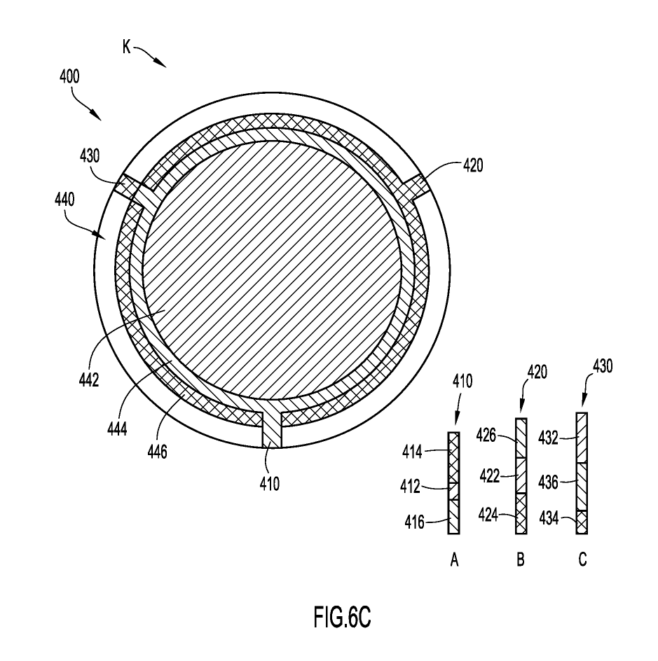

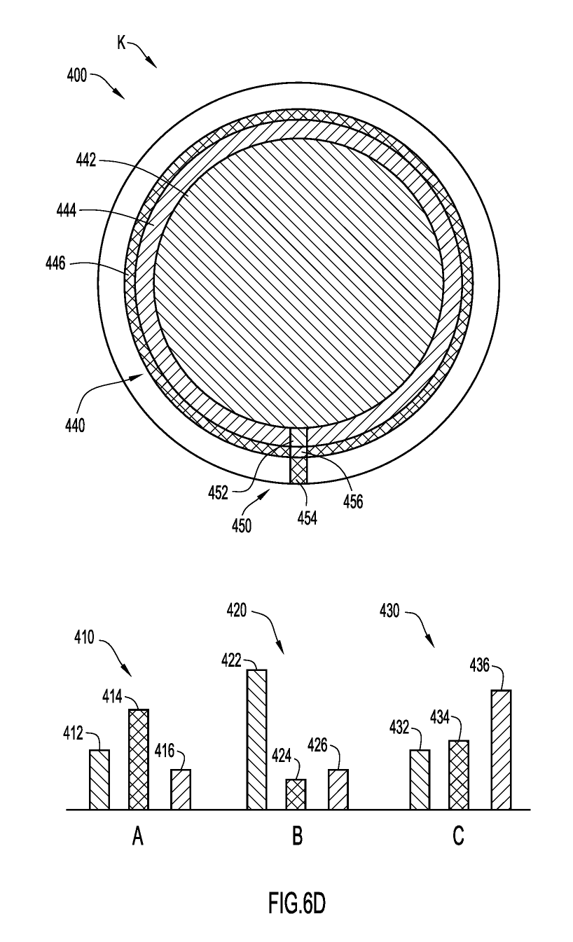

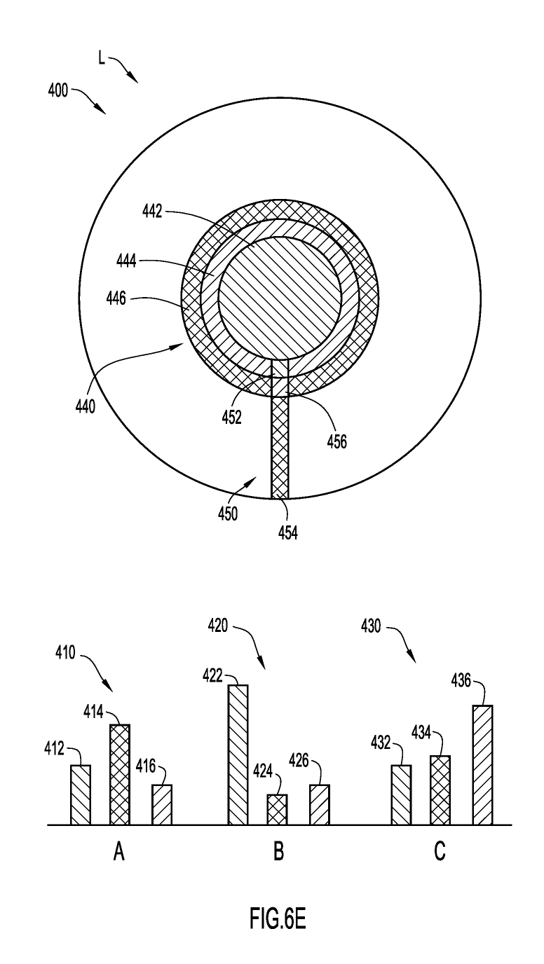

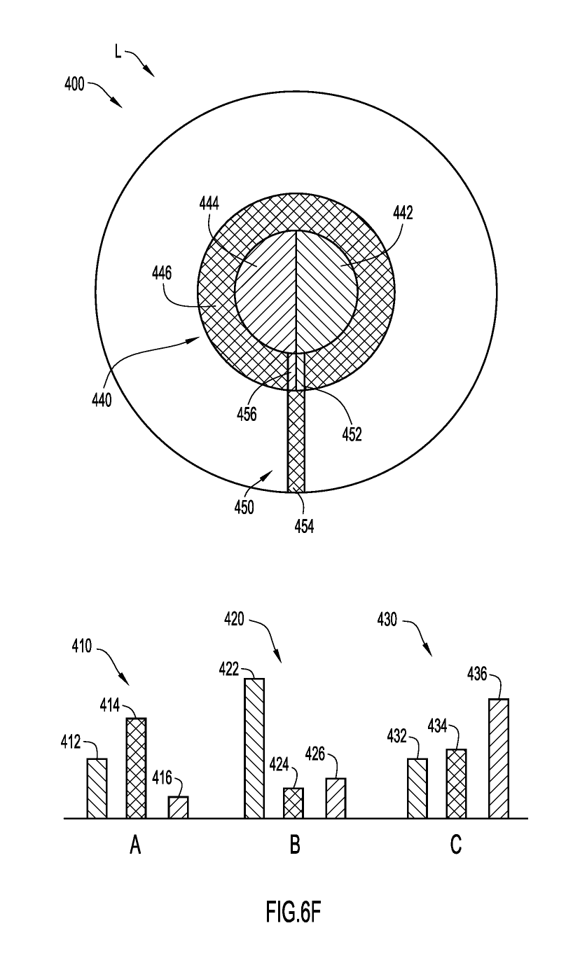

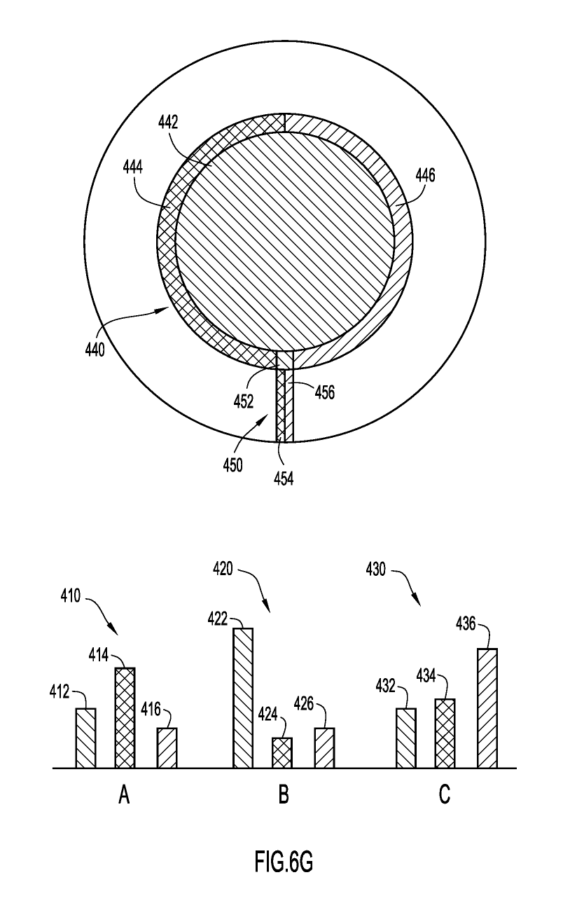

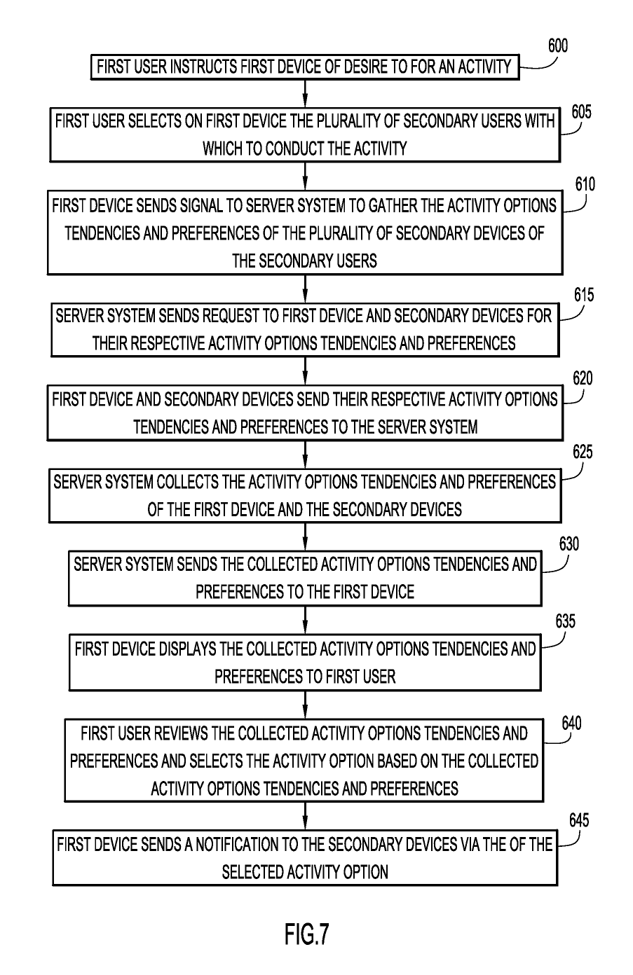

While FIGS. 5A and 5B illustrate a GUI 300 that is best suited for tendency/preference values that sum to unity (100%) or a common total, FIGS. 6A-6G illustrate a GUI 400 for tendency/preference values that do not sum to unity or a common total. Thus, the tendency/preference values illustrated in FIGS. 6A-6G might be based on user ratings or rankings. The GUI 400 illustrated in FIG. 6A may be defined by a circular area with a set of tendency/preference bars 410, 420, 430 radiating from a set of centrally located circles 442, 444, 446 in the central area 440 of the GUI 400. The tendency/preference bars 410, 420, 430 radiate from the central area 440 of the GUI 400 to the edge of the GUI 400. Each preference bar 410, 420, 430 represents a set of stacked tendency/preference values for multiple options for performing/completing an activity for each user A, B, C. The bars 410, 420, 430 located to the right of the GUI 400 may be for illustrative and informational purposes only, and may not form a part of the GUI 400. The bars 410, 420, 430 located to the right of the GUI 400 are representations of the bars 410, 420, 430 that are positioned equidistant from each other around the central area 440 of the GUI 400. The bar 410 radiating from the bottom of the central area 440 of the GUI 400 represents the tendency/preference values of user A, and is equivalent to the first bar 410 located to the right of the GUI 400. The bar 420 radiating from the upper right of the central area 440 of the GUI 400 represents the tendency/preference values of user B, and is equivalent to the second bar 420 located to the right of the GUI 400. Finally, the bar 430 radiating from the upper right of the central area 440 of the GUI 400 represents the tendency/preference values of user C, and is equivalent to the third bar 430 located to the right of the GUI 400. As described above, the tendency/preference values may be determined based on the numeral weights, scores, etc. that are calculated for criteria related to which options are available to each participant, the frequencies each of these options have been used for the activity, the option preferences of each participant for the activity, the order that each participant ranks the options in terms of familiarity, etc.

The tendency/preference bars 410, 420, 430 extend from the outer circumference of the GUI 400 towards the central area 440 of the GUI 400, where the stacked tendency/preference values closer to the outer circumference of the GUI 400 represent a lower tendency/preference value than those located proximate to the central area 440. The tendency/preference values increases as the bar extends from the outer circumference of the GUI 400 to the central area 440. Because each bar 410, 420, 430 is a set of stacked tendency/preference values for each option, the stacked tendency/preference values for each option may be colored or shaded differently from one another. For example, the first option may be represented by a green color, the second option may be represented by an orange color, and the third option may be represented by a blue color. In other embodiments of the present invention, the stacked tendency/preference values for each option may be shaded by a design, rather than a color. As illustrated in FIG. 6A, the tendency/preference bar 410 displayed by GUI 400 for user A shows that user A has the strongest tendency/preference towards the second option 414, a second strongest tendency/preference towards the first option 412, and the least tendency/preference for the third option 416. Furthermore, the tendency/preference bar 420 displayed in GUI 400 for user B shows that user B has the strongest tendency/preference towards the third option 426, a second strongest tendency/preference towards the first option 422, and the least tendency/preference for the second option 424. The tendency/preference bar 430 displayed in GUI 400 for user C shows that user C has the strongest tendency/preference towards the first option 432, a second strongest tendency/preference towards the third option 436, and the least tendency/preference for the second option 434.

The GUI 400 illustrated in FIG. 6A is an embodiment of the GUI 400 that is displaying the comparison of the preference/rating values from users A, B, and C by applying the most preferred guidelines, which were explained previously. As displayed by GUI 400, the central area 440 is made up of a central circle 442 with two bands 444, 446 concentrically located around the central circle 442. When GUI 400 applies the most preferred guideline to choosing the best option, the central area displays three circles 442, 444, 446 concentrically stacked on top of one another. The first central circle 442 is shaded to that of the most preferred option. The second central circle 444 is shaded to that of the second most preferred option. The second central circle 444 is shown as the first concentric band in FIG. 6A because the second central circle 444 has a larger diameter than the first central circle 442 but is concentrically positioned beneath the first central circle 442. In addition, the third central circle 446 is shaded to that of the least preferred option. The third central circle 446 is shown as the second concentric band in FIG. 6A because the third central circle 446 has the largest diameter of the central circles 442, 444, 446, and is concentrically positioned beneath the first and second central circle 442, 444. The larger diameters of the second and third central circles 444, 446 enables the GUI 400 to display the order of the options, with the first central circle 442 displaying the most preferred option for performing/completing the activity.

As illustrated in FIG. 6A, user A most prefers the second option 414, user B most prefers the third option 426, and user C most prefers the first option 432. However, user C prefers the first option 432 to a greater degree than user B prefers the third option 426 and a greater degree than user A prefers the second option 414. Furthermore, user B prefers the third option 426 to a greater degree than user A prefers the second option 414. Thus, the first central circle 442 of the central area 440 is shaded to represent the first option, the second central circle 444 is shaded to represent the third option, and the third central circle 446 is shaded to represent the second option.

Turning to FIG. 6B, illustrated is a set of GUI's 400 that demonstrate the ability of a user to interact with the GUI 400 to cycle through the different options for performing/completing an activity. The GUI 400 illustrated in FIG. 6B is the same GUI 400 illustrated in FIG. 6A, where the GUI 400 presents the order of the options using the most preferred guideline. As previously explained, based on the tendency/preference values from users A, B, and C, the first option is the most preferred option, the third option is the second most preferred option, and the second option is the least preferred communication option. FIG. 6A and the first GUI 400 illustrated on the left of FIG. 6B show the GUI 400 in the first configuration H, where the central area 440 displays all three central circles 442, 444, 446. The GUI 400 illustrated in the middle of FIG. 6B illustrates the second configuration I of the GUI 400, where the central area 440 displays the second and third central circles 444, 446 without displaying the first central circle 442. The GUI 400 illustrated on the right of FIG. 6B is in the third configuration J, where the central area 440 displays only the third central circle 446.

The GUI's 400 illustrated second from the left and second from the right include arrows X that are pointed in the substantially downward direction. The arrows X represents a user interaction with the GUI 400, where a user may select and swipe or drag the central area 440 of the GUI 400 in the downward direction of arrow X to cycle the central area 440 between the central circles 442, 444, 446. The second GUI 400 from the left of FIG. 6B illustrates the first configuration H with an arrow X, where performing the action of selecting and swiping the central area 440 in the direction of arrow X changes the central area 440 from primarily displaying the first central circle 442 to primarily displaying the second central circle 444. Similarly, the second GUI 400 from the right of FIG. 6B illustrates the second configuration I with an arrow X, where performing the action of selecting and swiping the central area 440 in the direction of arrow X changes the central area 440 from primarily displaying the second central circle 444 to primarily displaying the third central circle 446. While not illustrated, selecting and swiping the central area 440 of the GUI 400 in a substantially upward direction may cycle through the central circles 442, 444, 446 in the direction opposite of that when selecting and swiping the central area 440 of the GUI 400 in the direction of arrow X. In other embodiments, a user may be able to select and swipe the central region 440 of the GUI 400 in directions other than substantially upwardly and substantially downwardly to cycle through the central circles 442, 444, 446. In addition, selection of the central area 440 may send a notification to users A, B, and C that the central circle 442, 444, 446 that is primarily displayed has been selected or determined as the best option for performing or completing the activity.

Turning to FIG. 6C, illustrated is the GUI 400 from FIG. 6A, but with the least disliked guideline applied instead of the most preferred guideline to determined the best option to be used by users A, B, and C to perform the activity with each other. As illustrated in FIG. 6C, the GUI 400 is defined by a circular area with a set of tendency/preference bars 410, 420, 430 radiating from a set of centrally located circles 442, 444, 446 to the edge of the GUI 400. Each tendency/preference bar 410, 420, 430 represents a set of stacked tendency/preference values of multiple options for each user. As previously explained, the bars 410, 420, 430 located to the right of the GUI 400 may be for illustrative and informational purposes only, and are representations of the bars 410, 420, 430 that are positioned equidistant from each other around the central area 440 of the GUI 400.

Similar to those illustrated in FIG. 6A, the tendency/preference bars 410, 420, 430 illustrated in FIG. 6C extend from the outer circumference of the GUI 400 towards the central area 440 of the GUI 400, where the stacked tendency/preference values proximate to the outer circumference of the GUI 400 represent a lower tendency/preference value than those located proximate to the central area 440. The tendency/preference values increase as the bars extend from the outer circumference of the GUI 400 to the central area 440. Because each bar 410, 420, 430 is a set of stacked tendency/preference values for each option, the stacked tendency/preference bars may be colored or shaded differently from one another. For example, the first option may be represented by a green color, the second option may be represented by an orange color, and the third option may be represented by a blue color.

As illustrated in FIG. 6C, the tendency/preference bar 410 displayed by GUI 400 for user A shows that user A has the strongest tendency/preference towards the second option 414, a second strongest tendency/preference towards the first option 412, and the least tendency/preference for the third option 416. Furthermore, the tendency/preference bar 420 displayed in GUI 400 for user B shows that user B has the strongest tendency/preference towards the third option 426, a second strongest tendency/preference towards the first option 422, and the least tendency/preference for the second option 424. The tendency/preference bar 430 displayed in GUI 400 for user C shows that user C has the strongest tendency/preference towards the first option 432, a second strongest tendency/preference towards the third option 436, and the least tendency/preference for the second option 434.

By applying the least disliked guideline as applied in FIG. 6C, user A dislikes the third option 416 the most, and dislikes the first option 412 the second most. User B dislikes the second option 424 the most, and dislikes the first option 422 the second most. User C dislikes the second option 434 the most, and dislikes the third option 436 the second most. Because users B and C dislike the second option 424, 434 the most, and because user A dislikes the third option 416 more than user A dislikes first option 412, the least disliked option between all of the users A, B, C is the first option. Furthermore, the second least disliked option is the third option, and the most disliked option is the second option.

Similar to that of FIG. 6A, FIG. 6C illustrates the central area 440 as having a first central circle 442, a second central circle 444, and a third central circle 446, where the central circles 442, 444, 446 are concentrically placed on top of each other. The first central circle 442 is shaded to that of the least disliked option. The second central circle 444 is shaded to that of the second least disliked option. The second central circle 444 is shown as the first concentric band in FIG. 6C because the second central circle 444 has a larger diameter than the first central circle 442 but is concentrically positioned beneath the first central circle 442. In addition, the third central circle 446 is shaded to that of the most disliked option. The third central circle 446 is shown as the second concentric band in FIG. 6A because the third central circle 446 has the largest diameter of the central circles 442, 444, 446, and is concentrically positioned beneath the first and second central circle 442, 444.

As similarly explained in FIG. 6B, a user may be able to select and swipe in different directions the central area 440 of GUI 400 in FIG. 6C to primarily display one of the central circles 442, 444, 446. In addition, selecting the central circle 442, 444, 446 that is primarily displayed may send a notification to the users A, B, and C that it has been established that the option represented by the central circle 442, 444, 446 that is primarily displayed is the best option for performing the activity with users A, B, and C.

FIG. 6D illustrates a second example of the GUI 400 illustrated in FIG. 6C, where the least disliked guideline is applied. However, instead of each user A, B, C, being represented by their own stacked tendency/preference bar 410, 420, 430, the GUI 400 is represented by a single combined tendency/preference bar 450. FIG. 6D illustrates a first set of tendency/preference bars 410 for user A, a second set of tendency/preference bars 420 for user B, and a third set of tendency/preference bar 430 for user C. These sets of tendency/preference bars 410, 420, 430 are located beneath the GUI 400 may be for illustrative and informational purposes only, and may not form a part of the GUI 400. However, the single combined tendency/preference bar 450 is a representation of sets of tendency/preference bars 410, 420, 430 being combined. The combined tendency/preference bar 450 illustrated in FIG. 6D displays that the users A, B, and C dislike the first option 452 the least. The third option 456 is disliked the second least, and second option 454 is disliked the most by users A, B, and C. The single tendency/preference bar 450 is represented by the central circles 442, 444, 446 in a manner similar to that illustrated in FIG. 6C. The first central circle 442 represents the least disliked option, which is the first option 452. It then follows that the second central circle 444 represents the third option 456, and the third central circle 446 represents the second option 454.

Turning to FIGS. 6E, 6F, and 6G, illustrated is the GUI 400 of FIGS. 6A, 6B, 6C, and 6D where the GUI 400 in FIGS. 6E, 6F, and 6G are applying the greatest consensus guideline to determine the best option to be used to perform or complete an activity with users A, B, and C. The GUI 400 illustrated in FIGS. 6E, 6F, and 6G only includes one stacked tendency/preference bar 450. Moreover, the GUI 400 is defined by a circular area with the single tendency/preference bar 450 extending from a set of centrally located circles 442, 444, 446 to the edge of the GUI 400. Furthermore, FIGS. 6E, 6F, and 6G illustrate a first set of tendency/preference bars 410 for user A, a second set of tendency/preference bars 420 for user B, and a third set of tendency/preference bar 430 for user C. These sets of tendency/preference bars 410, 420, 430 are located beneath the GUI 400 may be for illustrative and informational purposes only, and may not form a part of the GUI 400. However, the tendency/preference bar 450 represents a combination of set of stacked tendency/preference values of each of the options for users A, B, and C.

As illustrated in FIGS. 6E, 6F, and 6G, the combined tendency/preference bar 450 has three tendency/preference sub-bars 452, 454, 456. Tendency/preference sub-bar 452 represents the combined sum of the values of the tendency/preference bar 412 of option 1 for user A, the tendency/preference bar 422 of option 1 for user B, and the tendency/preference bar 432 of option 1 for user C. Similarly, tendency/preference sub-bar 454 represents the combined sum of the values of the tendency/preference bar 414 of option 1 for user A, the tendency/preference bar 424 of option 1 for user B, and the tendency/preference bar 434 of option 1 for user C. Finally, tendency/preference sub-bar 456 represents the combined sum of the values of the tendency/preference bar 416 of option 1 for user A, the tendency/preference bar 426 of option 1 for user B, and the tendency/preference bar 436 of option 1 for user C. As described above, the tendency/preference values may be determined based on the numeral weights, scores, etc. that are calculated for criteria related to which options are available to each participant, the frequencies each of these options have been used for the activity, the option preferences of each participant for the activity, the order that each participant ranks the options in terms of familiarity, etc.

The tendency/preference bar 450 illustrated in FIGS. 6E, 6F, and 6G extends from the outer circumference of the GUI 400 towards the central area 440 of the GUI 400, where the stacked tendency/preference values closer to the outer circumference of the GUI 400 represent a lower tendency/preference value than those located proximate to the central area 440. The tendency/preference values increase as the bar 450 extends from the outer circumference of the GUI 400 to the central area 440.

As illustrated in FIG. 6E, for user A, the second option 414 has the highest tendency/preference value, the first option 412 has the second highest tendency/preference value, and the third option 416 has the lowest tendency/preference value. For user B, the first option 422 has the highest tendency/preference value, the third option 426 has the next highest tendency/preference value, and the second option 424 has the lowest tendency/preference value. For user C, the third option 436 has the highest tendency/preference value, the second option 434 has the second highest tendency/preference value, and the first option 432 has the lowest tendency/preference value. When applying the greatest consensus guideline, and the tendency/preference values from each of the users are added together for each of the options, the first option 452 is the most preferred option for performing an activity, the third option 456 is the second most preferred option for performing an activity, and the second option 454 is the least preferred option for performing an activity.

Similar to the GUI's 400 illustrated in FIGS. 6A-6D, FIG. 6E illustrates the central area 440 as having a first central circle 442, a second central circle 444, and a third central circle 446, where the central circles 442, 444, 446 are concentrically placed on top of each other. The first central circle 442 is shaded to that of the combined greatest preferred option. The second central circle 444 is shaded to that of the combined second greatest preferred option. The second central circle 444 is shown as the first concentric band in FIG. 6E because the second central circle 444 has a larger diameter than the first central circle 442 but is concentrically positioned beneath the first central circle 442. In addition, the third central circle 446 is shaded to that of the combined least preferred option. The third central circle 446 is shown as the second concentric band in FIG. 6E because the third central circle 446 has the largest diameter of the central circles 442, 444, 446, and is concentrically positioned beneath the first and second central circle 442, 444. Thus, for the example illustrated in FIG. 6E, the first central circle 442 is shaded the same as the first option 452 of the combined tendency/preference bar 450 because the first option 452 has the largest combined tendency/preference value from users A, B, and C. Moreover, the second central circle 444 is shaded the same as the third option 456 of the combined tendency/preference bar 450, and the third central circle 454 is shaded the same as the second option 454 of the combined tendency/preference bar 450.

FIG. 6F illustrates an example of the GUI 400 where the greatest consensus guideline is applied and there is a tie for the options having the greatest consensus between the users. For user A, the second option 414 has the highest tendency/preference value, the first option 412 has the second highest tendency/preference value, and the third option 416 has the lowest tendency/preference value. For user B, the first option 422 has the highest tendency/preference value, the third option 426 has the next highest tendency/preference value, and the second option 424 has the lowest tendency/preference value. For user C, the third option 436 has the highest tendency/preference value, the second option 434 has the second highest tendency/preference value, and the first option 432 has the lowest tendency/preference value. However, because of the specific tendency/preference values of each of the options for users A, B, and C, when applying the greatest consensus guideline to all of the tendency/preference values, the first option 452 and the third option 456 tie for the most preferred option for performing an activity. The second option 454 is the least preferred option for performing an activity.

Because there is a tie for the options having the greatest consensus between the users A, B, C, FIG. 6F displays a slightly different GUI 400 than the GUI 400 illustrated in FIG. 6E. Firstly, because the first option 452 and the third option 456 equivalent values for their tendency/preference, the combined tendency/preference bar 450 has two sections 452, 456 positioned adjacent to one another and extending equally as far into the central area 440 of the GUI 400. Both of these two sections 452, 456, which represent the first and third options for performing the activity, extend farther into the central area 440 than the section representing the second option 454. This is because the first and third options 452, 456 have a greater combined tendency/preference value than the second option 454.

In addition, the central area 440 of FIG. 6F differs from the central area 440 of FIG. 6E. Because the first option 452 and the third option 456 are tied for the largest combined tendency/preference value, a single central circle 442, 444, 446 is not located in the most central position on the central area 440. Instead the most central position of the central area 440 is shared by a first half circle 442, which represents the first option 452, and a second half circle 444, which represents the third option 456. The third central circle 446 is shaded to that of the combined least preferred option, which is the second option 454. The third central circle 446 is shown as a concentric band in FIG. 6F because the third central circle 446 has the largest diameter of the central circles 442, 444, 446, and is concentrically positioned beneath the first and second half circles 442, 444.

FIG. 6G illustrates a second example of the GUI 400 where the greatest consensus guideline is applied and there is a tie for the options having the second greatest consensus between the users. For user A, the second option 414 has the highest tendency/preference value, the first option 412 has the second highest tendency/preference value, and the third option 416 has the lowest tendency/preference value. For user B, the first option 422 has the highest tendency/preference value, the third option 426 has the next highest tendency/preference value, and the second option 424 has the lowest tendency/preference value. For user C, the third option 436 has the highest tendency/preference value, the second option 434 has the second highest tendency/preference value, and the first option 432 has the lowest tendency/preference value. When applying the greatest consensus guideline to all of the tendency/preference values for each of the options for users A, B, and C, the first option 452 is the most preferred option for performing an activity by users A, B, and C. However, the second option 454 and the third option 456 tie for the second most preferred option for performing an activity.

Because there is a tie for the options having the second greatest consensus between the users A, B, C, FIG. 6G displays a slightly different GUI 400 than the GUI's 400 illustrated in FIGS. 6E and 6F. Firstly, because the second option 454 and the third option 456 have equivalent values for their tendency/preference, the combined tendency/preference bar 450 has two sections 454, 456 positioned adjacent to one another and extending equally as far into the central area 440 of the GUI 400. Because the first option 452 has a tendency/preference value that is greater than both the second option 454 and the third option 456, the section of the combined tendency/preference bar 450 for the first option section 452 extends farther into the central area 440 of the GUI 400 than the sections for the second and third options 454, 456.

In addition, the central area 440 of FIG. 6G differs from the central area 440 of FIGS. 6E and 6F. Because the first option 452 has the largest combined tendency/preference value, the central area 440 includes a first central circle 442. However, because the second option 454 and the third option 456 are tied for the second largest combined tendency/preference value, the second option 454 is represented by a first half circle 444 and the third option 456 is represented by an equally sized second half circle 446. The first half circle 444 and the second half circle 446 are shown as a half concentric bands in FIG. 6G because the first half circle 444 and the second half circle 446 have a combined diameter that is larger than the diameter of the first central circles 442 and is concentrically positioned beneath the first and second half circles 442, 444.

Ties can be between any number of options and displayed in a similar fashion to that described above.

As similarly explained in FIG. 6B, a user may be able to select and swipe the central area 440 of the GUI 400 in FIGS. 6E, 6F, and 6G in different directions to primarily display one of the central circles or half circles 442, 444, 446. In addition, selecting the central circle 442, 444, 446 primarily displayed may send a notification to the multiple users that the option represented by the central circle 442, 444, 446 that is primarily displayed has been established as the best option for performing the activity by the multiple users. However, in an embodiment of the present invention, when the central area 440 is displaying two half circles, selecting one of the half circles over the other half circle may send a notification to the multiple users that the option selected has been established as the best option for performing the activity by the multiple users. In another embodiment of the present invention where the central area 440 is displaying two half circles, selection of the central area 440 by one of the users may randomly select one of the options represented by one of the two half circles.

Turning to FIG. 7, illustrated is a flow chart of the steps performed for establishing the best option for an activity for the plurality of selected users, and then completing or performing the activity via the selected activity option between the plurality of users. For example, if a user wishes to go out to dinner with friends, there will be a variety of different restaurants to choose between, and each participant will have an opinion for which restaurant they prefer. This embodiment of the present invention may aid the user in selecting the restaurant best suited for going to dinner with all of the participants. Moreover, the flow chart illustrated in FIG. 7 may be performed by the multiple devices (e.g., server system 100 and client systems 140, 140′) illustrated in FIG. 1. At block 600, a first user instructs the first device (e.g., client system 140) that the user wishes to perform an activity. The activity could be any type of activity to be performed by two or more participants, such as establishing a communication link, going out to dinner, attending to a movie, etc. At block 605, the first user selects on the first device one or more of the secondary users with which the first user wishes to perform the activity. At block 610, the first device sends a signal to the server system (e.g., server system 100) of the desire to perform the activity and to gather the activity options tendencies and preferences from the first device of the first user and secondary devices (e.g., client system 140′) of the secondary users. The activity options tendencies and preferences may be the frequency that a user selects a certain option for the desired activity, the user's preferences for each available option for the desired activity, the rankings the user has given the options of the desired activity, etc. At block 615, the server system sends requests to the first device and the secondary devices for their respective activity options tendencies and preferences for the desired activity. At block 620, the first device and the secondary devices send their respective activity options tendencies and preferences to the server system. In some embodiments, the devices may receive and send their respective activity options tendencies and preferences without interaction or permission from the users. In other embodiments, the devices may receive a notification that the server system is requesting the Activity Options Tendencies and Preferences for that respective Device. In this embodiment, the users may be required to accept or deny the request for the activity options tendencies and preferences to be sent to the server system.

At block 625, the server system collects the activity options tendencies and preferences from the first device and the secondary devices and determines tendency/preference values. For example, sum, weight, normalized measurements/ratings, etc. At block 630, the server system then sends the activity options tendencies and preferences to the first device. The next step, at block 635, is that the first device displays the activity options tendencies and preferences to the first user. The first device may display the activity options tendencies and preferences using one of the GUI's 200, 300, 400 illustrated in FIGS. 3A, 3B, 4A, 4B, 4C, 5A, 5B, and 6A-6G. At block 640, the first user reviews the compiled activity options tendencies and preferences and selects the best activity option based on the activity options tendencies and preferences. The first user may choose the activity option by selecting the activity option in the manners discussed with respect to the GUI's 200, 300, 400 illustrated in FIGS. 3A, 3B, 4A, 4B, 4C, 5A, 5B, and 6A-6G. Moreover, the first user may interact with GUI's 200, 300, 400 and apply one of the various guidelines for displaying the best activity option from the activity options tendencies and preferences.

Finally, at block 645, the first device may send a notification to the secondary devices regarding the selected activity option. For example, when the activity to be performed is going out to dinner between a plurality of participants, the first device may send a notification to the participants that a certain restaurant has been chosen for as the best restaurant for all of the participants to attend. Further, the first device may initiate the activity, such as establishing communications.

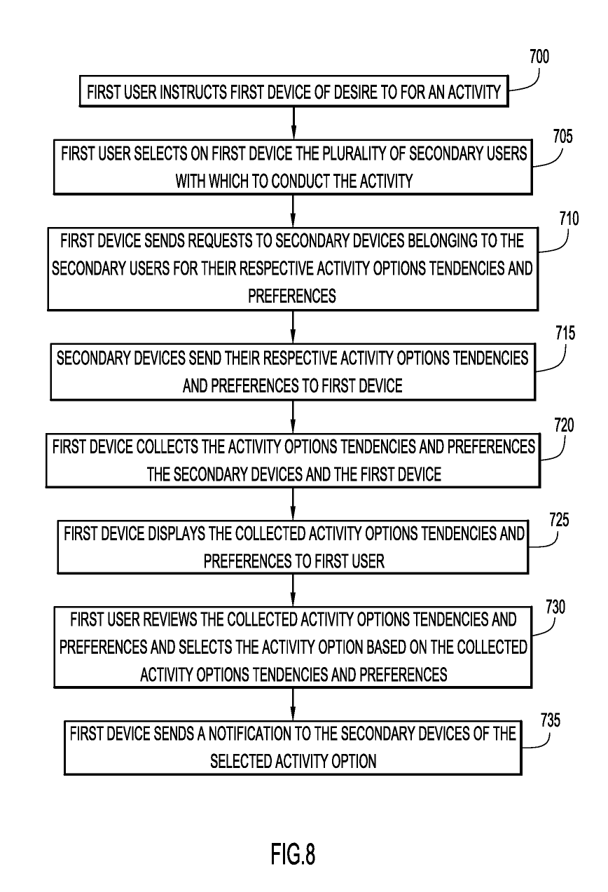

FIG. 8 is a flow chart of an alternative manner for establishing a best option for an activity. The flow chart of FIG. 8 may be performed by the multiple devices illustrated in FIG. 2. At block 700, the first user instructs the first device that the user wishes to perform an activity. As previously explained, the activity could be any type of activity to be performed by two or more participants. At block 705, the first user selects on the first device (e.g., client system 140) the plurality of secondary users with which the first user wishes to perform the activity. At block 710, the first device sends a request to the secondary devices (e.g., client systems 140′, 140″, 140″), which belong to the secondary users, for their respective activity options tendencies and preferences. As explained previously, the activity options tendencies and preferences may be the frequency that a user selects a certain option for the desired activity, the user's preferences for each available option for the desired activity, or the rankings the user has given the options of the desired activity. At block 715, the secondary devices send their respective activity options tendencies and preferences to the first device. The secondary devices may send their activity options tendencies and preferences with or without interaction or permission from their respective users, and with or without receiving a notification of the request for the activity options tendencies and preferences.

At block 720, the first device collects the activity options tendencies and preferences from the secondary devices and the first device and determines the tendency/preference values as described above. At block 725, the first device displays the compiled activity options tendencies and preferences to the first user. The first device may display the activity options tendencies and preferences using one of the GUI's 200, 300, 400 illustrated in FIGS. 3A, 3B, 4A, 4B, 4C, 5A, 5B, and 6A-6G. At block 730, the first user reviews the compiled activity options tendencies and preferences and selects the best activity option based on the collected activity options tendencies and preferences. The first user may choose the activity option by selecting the activity option in the manners discussed with respect to the GUI's 200, 300, 400 illustrated in FIGS. 3A, 3B, 4A, 4B, 4C, 5A, 5B, and 6A-6G. Moreover, the first user may interact with GUI's 200, 300, 400 and apply one of the various guidelines (greatest consensus, most preferred, least disliked, etc.) for displaying the best activity option from the collected activity options tendencies and preferences. Finally, at block 735, the first device may send a notification to the secondary devices regarding the selected activity option.

It will be appreciated that the embodiments described above and illustrated in the drawings represent only a few of the many ways of implementing embodiments for monitoring actions and determining the best option for performing an activity with multiple participants.

The embodiments described above and illustrated in the drawings streamline how two or more devices communicate with one another. The embodiments described above may continuously monitor the preferences, limitations, behaviors, and capabilities of each of the participants and may establish the best option for performing an activity with multiple participants. The monitoring of these preferences, limitations, behaviors, and capabilities may be completed by various types of sensors and monitoring devices. The presented interactive displays described above and illustrated in the drawings streamline the decision process for determining the best option for performing an activity. Moreover, the interactive displays may automatically notify the participants of the determined best option for performing an activity. The embodiments described above eliminate the need for decision making process by the computer system or the participants when determining which option should be selected for performing an activity. When the activity to be performed may be performed by a computer system, the described interfaces may not only present the best determined option for the activity to be performed, but may also automatically instruct the computer system to perform the activity via the determined best option without the user instructing the computer system to perform the activity via the determined best option.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, activity collection module, activity tendency module, display module, etc.). These systems may include any types of monitors and input devices (e.g., keyboard, mouse, voice recognition, etc.) to enter and/or view information.

It is to be understood that the software (e.g., activity tendency module, display module, activity collection module, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., activity tendency module, display module, activity collection module, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., user profiles, activity option tendencies, frequency of selection of activity options, rankings of activity options, preference of users for activity options, etc.). The database system may be implemented by any number of any conventional or other databases, data stores or storage structures (e.g., files, databases, data structures, data or other repositories, etc.) to store information (e.g., user profiles, activity option tendencies, frequency of selection of activity options, rankings of activity options, preference of users for activity options, etc.). The database system may be included within or coupled to the server and/or client systems. The database systems and/or storage structures may be remote from or local to the computer or other processing systems, and may store any desired data (e.g., user profiles, activity option tendencies, frequency of selection of activity options, rankings of activity options, preference of users for activity options, etc.).

The present invention embodiments may employ any number of any type of user interface (e.g., Graphical User Interface (GUI), command-line, prompt, etc.) for obtaining or providing information (e.g., activity option tendencies, frequency of selection of activity options, rankings of activity options, preference of users for activity options, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., text analytics, profile scores, activity option tendencies, frequency of selection of activity options, rankings of activity options, preference of users for activity options, etc.).

The present invention embodiments are not limited to the specific tasks or algorithms described above, but may be utilized for determining an option for performing or completing any activity between multiple participants by analyzing the preferences, limitations, and capabilities of each of the participants.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of conducting an activity among a plurality of participants comprising:
generating a graphical display of magnitudes of preferences of each participant pertaining to each of a plurality of options for an item required for conducting an activity;
combining the magnitudes of the preferences of each participant for each of the options and determining the option for the item to employ for the activity based on the combined magnitudes; and
graphically displaying the determined option for the item to conduct the activity employing the determined option.

2. The method of claim 1, wherein the plurality of participants includes two participants, the graphical display includes a chart for each participant with a plurality of bars each indicating the magnitude of a preference for a corresponding option, and combining the magnitudes comprises:
manipulating the charts of the two participants toward each other and identifying the option for the item for the activity based on contact between the corresponding bars of a preference for an option of the item.

3. The method of claim 1, wherein the magnitudes include preference values, and combining the magnitudes of the preferences comprises:
summing the preference values of each of the participants for each of the options of the item and identifying the option of the item based on a greatest summation of preference values.

4. The method of claim 1, wherein combining the magnitudes of the preferences comprises:
identifying the option for the item based on a greatest magnitude of the preferences for the options.

5. The method of claim 1, wherein combining the magnitudes of the preferences comprises:
identifying an option for the item based on a magnitude of the preference of each participant for that option being greater than a lowest magnitude of a preference of each participant for each of the options for the item.

6. The method of claim 1, wherein the graphical display includes a plurality of concentric bands and a plurality of stacked bars, each concentric band and stacked bar being associated with a corresponding participant and employing a color-coding scheme to indicate a preference of each participant for each of the plurality of options for the item, wherein the stacked bars are presented in a radial fashion around the concentric bands, and wherein the plurality of concentric bands are color-coded and represent determined options for the item in order of preference.

7. The method of claim 6, wherein the graphical display presents the plurality of concentric bands and the plurality of stacked bars as divided evenly between at least two options for the item to represent equal preference of the at least two options by the plurality of participants.
